(19) United States
(12) Patent Application Publication
(10) Pub. No.: US 2009/0150589 A1
(43) Pub. Date: Jun. 11, 2009

(54) HOT-PLUG SIGNAL OUTPUT APPARATUS AND HOT-PLUG SIGNAL INPUT/OUTPUT APPARATUS

(76) Inventors: Chikara WATARAI, Neyagawa-shi (JP); Yiran Sun, Neyagawa-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/251,535

(22) Filed: Oct. 15, 2008

(30) Foreign Application Priority Data
Dec. 7, 2007 (JP) 2007-317658
Jan. 17, 2008 (JP) 2008-007476

(51) Int. Cl. G06F 13/00

(52) U.S. Cl. 710/302

(57) ABSTRACT

Output control section detects, when the hot-plug line is conducted to the source device's hot-plug line, the data communication line is conducted to the source device's data communication line, and the power supply voltage line is not conducted to the source device's power supply voltage line, that a voltage is not supplied from the source device's power supply voltage line to the power supply voltage line and a voltage is supplied from the source device's data communication line to the data communication line, and thus bringing the switching section into an open state, whereby the voltage supplied from the source device's data communication line to the data communication line is inhibited from being supplied from the hot-plug line to the source device's hot-plug line; and detecting, when the hot-plug line is conducted to the source device's hot-plug line, the data communication line is conducted to the source device's data communication line, and the power supply voltage line is conducted to the source device's power supply voltage line, that a voltage is supplied from the source device's power supply voltage line to the power supply voltage line, and thus bringing the switching section into a conduction state, whereby the voltage supplied to the power supply voltage line is allowed to be supplied, as a hot-plug signal, from the hot-plug line to the source device's hot-plug line.

### BACKGROUND OF THE INVENTION

1. Field of the Invention

The present invention relates to a hot-plug signal output apparatus. The present invention also relates to a hot-plug signal input/output apparatus that accepts as input a hot-plug signal from a sink device and outputs the hot-plug signal to a source device.

2. Description of the Related Art

### (The Related Art 1)

In recent years, an AV system has proliferated that includes a source device that supplies content data such as video data and audio data; and content receiving apparatuses, such as a sink device and a repeater device, that receive the content data. The source device is, for example, a DVD player, a blu-ray disc player, or an HD DVD (High Definition DVD) player. The sink device is, for example, an LCD (Liquid Crystal Display), a PDP (Plasma Display Panel), a projector, or the like. The repeater device is, for example, an AV amplifier or an AV receiver. These devices comply with an HDMI standard and are connected to each other through HDMI cables.

FIG. 1 is a schematic block diagram describing a main part of an AV amplifier 10. The AV amplifier 10 includes an HDMI receiving unit 11, an HDMI transmitting unit 12, a control unit 13, and connectors 14 and 15. To the connector 14 is connected, for example, a DVD player 20 through an HDMI cable. To the connector 15 is connected, for example, a display apparatus through an HDMI cable.

The AV amplifier 10 mainly includes, as HDMI lines, a hot-plug line 17, a DDC line 18, and a 5V power supply line 19. The hot-plug line 17 outputs a hot-plug signal for notifying that the AV amplifier 10 is connected to the DVD player 20 through an HDMI cable. Specifically, when a hot-plug signal supplied from the AV amplifier 10 is at a low level, the DVD player 20 determines that the AV amplifier 10 is not active (“active” indicates a state of being able to receive and process HDMI data) or the AV amplifier 10 is not connected thereto; and when the hot-plug signal is at a high level, the DVD player 20 determines that the AV amplifier 10 is connected thereto. The DDC line 18 is used to obtain, by the DVD player 20, information (EDID, authentication information, etc.) about the AV amplifier 10 for authentication. The 5V power supply line 19 is connected to the hot-plug line 17 and the DDC line 18 and supplies a 5V power supply voltage thereto.

FIG. 2 is a schematic block diagram describing a main part of the DVD player 20. The DVD player 20 includes an HDMI transmitting unit 31, a control unit 32, a reproducing unit 33, and a connector 34. The DVD player 20 also includes a hot-plug line 35, a DDC line 36, and a 5V power supply line 37. To the connector 34 is connected, for example, an AV amplifier 10 through an HDMI cable.

FIG. 11 is a circuit diagram describing a hot-plug signal output unit 66 of the AV amplifier 10. The hot-plug signal output unit 66 includes transistors Q61 and Q62 and resistors R62 and R63. When a high-level signal is supplied from the control unit 13 to a base of the transistor Q61, the transistor Q61 goes into an on state and a base of the transistor Q62 is connected to a ground potential. When, in such a state, the DVD player 20 is connected to the AV amplifier 10 through an HDMI cable, a voltage is supplied from the 5V power supply line 37 of the DVD player 20 to the 5V power supply line 19 of the AV amplifier 10 and the voltage is then supplied to an emitter of the transistor Q62. As a result, the transistor Q62 goes into an on state and the voltage is outputted, as a high-level hot-plug signal, to the hot-plug line 35 of the DVD player 20 through the resistor R62 and the hot-plug line 17.

However, the hot-plug signal output unit 66 has a following problem. Specifically, since among the connector terminals of the HDMI cable the terminal of a 5V power supply line is shorter than other terminals, when connecting the connector 34 of the DVD player 20 to the connector 14 of the AV amplifier 20 through an HDMI cable, if the connection between the HDMI cable and the connector 14 or 34 is insufficient (or when the connection is being established by a user), a state may be brought about in which only the 5V power supply line among all lines is not conducted (not electrically connected). That is, a state may be brought about in which the hot-plug line 17 of the AV amplifier 10 is conducted to the hot-plug line 35 of the DVD player 20, the DDC line 18 of the AV amplifier 10 is conducted to the DDC line 36 of the DVD player 20, and the 5V power supply line 19 of the AV amplifier 10 is not conducted to the 5V power supply line 37 of the DVD player 20.

Since this is a state in which the AV amplifier 10 is not connected to the DVD player 20, a high-level hot-plug signal should not be outputted from the hot-plug line 17 of the AV amplifier 10 to the hot-plug line 35 of the DVD player 20. However, although a voltage is not supplied from the 5V power supply line 37 of the DVD player 20 to the 5V power supply line 19 of the AV amplifier 10, a 5V power supply voltage from the DVD player 20 is supplied to the DDC line 18 of the AV amplifier 10 through a resistor R31 and the DDC line 36. The voltage supplied to the DDC line 18 of the AV amplifier 10 is supplied to the emitter of the transistor Q62 through a resistor R61 and thus the transistor Q62 goes into an on state. As a result, the voltage supplied to the DDC line 18 is supplied to the hot-plug line 35 of the DVD player 20 through the resistors R61 and R62 and the hot-plug line 17.

Since the hot-plug line 35 of the DVD player 20 is connected to a ground potential through a resistor R32, the 5V voltage supplied to the DDC line 18 is divided by the resistors R32, R61, and R62 and thus a voltage of about 1 to 2V is supplied to the hot-plug line 35 of the DVD player 20. As a result, despite the fact that a hot-plug signal of the AV amplifier 10 is not at a high level, due to a voltage of about 1 to 2V being supplied to the hot-plug line 35, when the voltage exceeds a threshold voltage, the DVD player 20 may misdetect that a high-level hot-plug signal has been supplied thereto.

When the DVD player 20 misdetects a high-level hot-plug signal, a malfunction occurs, for example, that the HDMI transmitting unit 31 of the DVD player 20 attempts to read authentication information from the HDMI receiving unit 11 of the AV amplifier 10 for authentication, but fails authentication. Furthermore, even if a normal high-level hot-plug signal is supplied afterward from the AV amplifier 10 to the hot-plug line 35 of the DVD player 20, the DVD player 20 cannot perform an operation responsive thereto for the following reason. When inversion of a hot-plug signal from a low level to a high level is detected, the DVD player performs processes. However, when the DVD player misdetects that a voltage supplied from the DDC line 18 to the hot-plug line 35 is a high-level hot-plug signal, the DVD player cannot thereafter detect inversion of the hot-plug signal to a low level.

Alternatively, although the high-level hot-plug signal is 5V, when a voltage of about 1 to 2V is supplied to the hot-plug line 35, electronic components provided in the DVD player 20 may be damaged.

FIG. 12 is a schematic diagram showing a hot-plug signal output unit 86 according to another embodiment. In the hot-plug signal output unit 86, when a hot-plug line 17 of the AV amplifier 10 is conducted to the hot-plug line 35 of the DVD player 20, a DDC line 18 of the AV amplifier 10 is conducted to the DDC line 36 of the DVD player 20, and a 5V power supply line 19 of the AV amplifier 10 is not conducted to the 5V power supply line 37 of the DVD player 20, a 5V power supply voltage of the DVD player 20 is also supplied to the DDC line 18 of the AV amplifier 10 through the resistor R31 and the DDC line 36. The voltage supplied to the DDC line 18 of the AV amplifier 10 is supplied to the hot-plug line 35 of the DVD player 20 through resistors R81 and R82 and the hot-plug line 17. As a result, as in the case above, the DVD player 20 misdetects that the voltage is a high-level hot-plug signal, causing a malfunction.

### (The Related Art 2)

In recent years, an AV system has proliferated that includes a source device that supplies content data (hereinafter, referred to as HDMI data) such as video data and audio data; and content receiving apparatuses, such as a sink device and a repeater device, that receive the HDMI data supplied from the source device. Moreover, there exists an HDMI switcher that selects one of HDMI data units supplied from a plurality of source devices, receives the selected HDMI data unit, and supplies the selected HDMI data unit to a sink device.

The source device is, for example, a DVD player, a blu-ray disc player, an HD DVD (High Definition DVD) player, or the like. The sink device is, for example, an LCD (Liquid Crystal Display), a PDP (Plasma Display Panel), a projector, or the like. The repeater device or the HDMI switcher is, for example, an AV amplifier, an AV receiver, or the like. These devices comply with the HDMI standard and are connected to each other through HDMI cables.

FIG. 13 is a block diagram describing a conventional AV amplifier (HDMI switcher) 50. The AV amplifier 50 includes an HDMI switch 11, a 5V power supply unit 12, and connectors 13 and 14. To the connector 13 is connected, for example, a DVD player 20 through an HDMI cable. To the connector 14 is connected, for example, a display apparatus 30 through an HDMI cable.

The AV amplifier 50 mainly includes, as HDMI lines, hot-plug lines 15a and 15c, DDC lines 16a and 16c, and 5V power supply lines 17a and 17c. The hot-plug line 15a outputs to the DVD player 20 a hot-plug signal for notifying the DVD player 20 that the AV amplifier 50 is connected to the DVD player 20 through an HDMI cable. Specifically, when a hot-plug signal supplied from the AV amplifier 50 is at a low level, the DVD player 20 determines that the AV amplifier 50 is not active (“active” indicates a state of being able to receive and process HDMI data) or the AV amplifier 50 is not connected thereto; and when the hot-plug signal is at a high level, the DVD player 20 determines that the AV amplifier 50 is connected thereto.

The DDC lines 16a and 16c are used to obtain, by the DVD player 20, information (EDID, authentication information, etc.) about the AV amplifier 50 (and the display apparatus 30), for authentication. The 5V power supply lines 17a and 17c are respectively connected to the DDC lines 16a and 16c and supply a 5V power supply voltage thereto.

FIG. 7 is a block diagram showing the DVD player 20. The DVD player 20 includes an HDMI transmitting unit 21, a control unit 22, a reproducing unit 23, and a connector 24. The DVD player 20 also includes a hot-plug line 25, a DDC line 26, and a 5V power supply line 27. To the connector 24 is connected, for example, an AV amplifier 50 through an HDMI cable.

FIG. 8 is a block diagram showing the display apparatus 30. The display apparatus 30 includes an HDMI receiving unit 31, a control unit 32, and a connector 33. The display apparatus 30 also includes a hot-plug line 35, a DDC line 36, and a 5V power supply line 37. To the connector 33 is connected, for example, an AV amplifier 50 through an HDMI cable.

With reference to FIGS. 7, 8, and 13, hot-plug signals to be inputted and outputted when the apparatuses are connected to each other through HDMI cables will be described. When the DVD player 20 is connected to the AV amplifier 50 through an HDMI cable, a 5V power supply voltage is supplied from the 5V power supply line 27 of the DVD player 20 to the 5V power supply line 17a of the AV amplifier 50 and the 5V power supply voltage is supplied to the HDMI switch 11. By this, the HDMI switch 11 supplies to the 5V power supply unit 12 a control signal for allowing to output a voltage, and thus, the 5V power supply unit 12 supplies a 5V power supply voltage to the 5V power supply line 17c.

When the display apparatus 30 is connected to the AV amplifier 50 through an HDMI cable, a 5V power supply voltage is supplied from the 5V power supply line 17c of the AV amplifier 50 to the 5V power supply line 37 of the display apparatus 30. The voltage supplied to the 5V power supply line 37 is supplied, as a high-level hot-plug signal, to the hot-plug line 15c of the AV amplifier 50 through the hot-plug line 35. The high-level hot-plug signal supplied to the hot-plug line 15c is outputted to the hot-plug line 25 of the DVD player 20 through the HDMI switch 11 and the hot-plug line 15a. The HDMI transmitting unit 21 of the DVD player 20 detects the high-level hot-plug signal and can thereby recognize that the AV amplifier 50 (and the display apparatus 30) have been connected thereto.

However, the AV amplifier 50 has a following problem. Specifically, since among the connector terminals of an HDMI cable the terminal of a 5V power supply line is shorter than other terminals, when connecting the connector 24 of the DVD player 20 to the connector 13 of the AV amplifier 50 through an HDMI cable, if the connection between the HDMI cable and the connector 13 or 24 is insufficient (or when the connection is being established by a user), a state may be brought about in which only the 5V power supply line among all lines is not conducted (not electrically connected). That is, a state may be brought about in which the hot-plug line 15a of the AV amplifier 50 is conducted to the hot-plug line 25 of the DVD player 20, the DDC line 16a of the AV amplifier 50 is conducted to the DDC line 26 of the DVD player 20, and the 5V power supply line 17a of the AV amplifier 50 is not conducted to the 5V power supply line 27 of the DVD player 20.

Since this is a state in which the AV amplifier 50 is not connected to the DVD player 20, a high-level hot-plug signal should not be outputted from the hot-plug line 15a of the AV amplifier 50 to the hot-plug line 25 of the DVD player 20. However, although a 5V power supply voltage is not supplied from the 5V power supply line 27 of the DVD player 20 to the 5V power supply line 17a of the AV amplifier 50, a 5V power supply voltage from the DVD player 20 is supplied to the DDC line 16a of the AV amplifier 50 through a resistor R21 and the DDC line 26. The 5V power supply voltage supplied to the DDC line 16a of the AV amplifier 50 is supplied to the HDMI switch 11 through a resistor R1. As a result, the HDMI switch 11 supplies a control signal to the 5V power supply unit 12 and thus the 5V power supply unit 12 supplies a 5V power supply voltage to the 5V power supply line 17c and the 5V power supply voltage is supplied to the 5V power supply line 37 of the display apparatus 30. Accordingly, the voltage supplied to the 5V power supply line 37 is supplied, as a high-level hot-plug signal, to the hot-plug line 15c of the AV amplifier 50 through the hot-plug line 35 and outputted to the hot-plug line 25 of the DVD player 20 through the HDMI switch 11 and the hot-plug line 15a.

As a result, despite the fact that the AV amplifier 50 is not connected to the DVD player 20, due to the high-level hot-plug signal being supplied to the DVD player 20, the DVD player 20 misdetects that the AV amplifier 50 has been connected thereto. When a high-level hot-plug signal is misdetected, a malfunction occurs, for example, that the HDMI transmitting unit 21 of the DVD player 20 attempts to read authentication information from the AV amplifier 50 or the display apparatus 30, for authentication but fails authentication. Furthermore, even if a normal high-level hot-plug signal is supplied afterward from the AV amplifier 50 to the hot-plug line 25 of the DVD player 20, the DVD player 20 cannot perform an operation responsive thereto for the following reason. When inversion of a hot-plug signal from a low level to a high level is detected, the DVD player performs processes. However, when the DVD player misdetects a high-level hot-plug signal based on a voltage supplied through the DDC line 16a, the DVD player cannot thereafter detect inversion of the hot-plug signal to a low level.

### SUMMARY OF THE INVENTION

An object of the present invention is to provide a hot-plug signal output apparatus that prevents a voltage from being supplied to a source device's hot-plug line when a hot-plug line of the apparatus is conducted to the source device's hot-plug line, a DDC line of the apparatus is conducted to a source device's DDC line, and a 5V power supply line of the apparatus is not conducted to a source device's 5V power supply line.

A hot-plug signal output apparatus as a preferred embodiment of the present invention that outputs a hot-plug signal to a source device having a source device's hot-plug line, a source device's data communication line, and a source device's power supply voltage line, the apparatus comprising: a hot-plug line that can be connected to the source device's hot-plug line; a data communication line that can be connected to the source device's data communication line; a power supply voltage line that is connected to the data communication line and to the hot-plug line through switching section and that can be connected to the source device's power supply voltage line; and output control section for detecting, when the hot-plug line is conducted to the source device's hot-plug line, the data communication line is conducted to the source device's data communication line, and the power supply voltage line is not conducted to the source device's power supply voltage line, that a voltage is not supplied from the source device's power supply voltage line to the power supply voltage line and a voltage is supplied from the source device's data communication line to the data communication line, and thus bringing the switching section into an open state, whereby the voltage supplied from the source device's data communication line to the data communication line is inhibited from being supplied from the hot-plug line to the source device's hot-plug line; and detecting, when the hot-plug line is conducted to the source device's hot-plug line, the data communication line is conducted to the source device's data communication line, and the power supply voltage line is conducted to the source device's power supply voltage line, that a voltage is supplied from the source device's power supply voltage line to the power supply voltage line, and thus bringing the switching section into a conduction state, whereby the voltage supplied to the power supply voltage line is allowed to be supplied, as a hot-plug signal, from the hot-plug line to the source device's hot-plug line.

Hence, when the hot-plug line is conducted to the source device's hot-plug line, the data communication line is conducted to the source device's data communication line, and the power supply voltage line is not conducted to the source device's power supply voltage line, it is possible to prevent a voltage supplied from the source device's data communication line to the data communication line from being supplied from the hot-plug line to the source device's hot-plug line, and the source device from mistakenly determining that the voltage is a hot-plug signal. Accordingly, it is possible to prevent a malfunction from occurring in the source device.

In a further preferred embodiment, the power supply voltage line is connected to the data communication line through a first resistor, the source device's hot-plug line is connected to a ground potential through a second resistor, the switching section includes a transistor, the output control section includes a Zener diode having a cathode connected to a control electrode of the transistor, and having an anode controlled to be connected to a ground potential, the transistor goes into an off state by a current not flowing through the Zener diode when the hot-plug line is conducted to the source device's hot-plug line, the data communication line is conducted to the source device's data communication line, and the power supply voltage line is not conducted to the source device's power supply voltage line, and the transistor goes into an on state by a current flowing through the Zener diode when the hot-plug line is conducted to the source device's hot-plug line, the data communication line is conducted to the source device's data communication line, and the power supply voltage line is conducted to the source device's power supply voltage line.

When the hot-plug line is conducted to the source device's hot-plug line, the data communication line is conducted to the source device's data communication line, and the power supply voltage line is not conducted to the source device's power supply voltage line, since a voltage supplied from the source device's data communication line to the data communication line is divided by the first resistor and the second resistor, the voltage between the cathode and anode of the Zener diode is less than a conduction start voltage (Zener voltage) of the Zener diode. Hence, since a current does not flow through the Zener diode, a current does not flow between the control electrode and another electrode of the transistor and thus the transistor goes into an off state. As a result, the voltage from the data communication line is inhibited from being supplied to the source device's hot-plug line. On the other hand, when the hot-plug line is conducted to the source device's hot-plug line, the data communication line is conducted to the source device's data communication line, and the power supply voltage line is conducted to the source device's power supply voltage line, since a voltage from the power supply voltage line is not divided by the first resistor and the second resistor, the voltage between the cathode and anode of the Zener diode is equal to or higher than the conduction start voltage of the Zener diode. Hence, since a current flows through the Zener diode, a current flows between the control electrode and another electrode of the transistor and thus the transistor goes into an on state. As a result, the voltage from the power supply voltage line is allowed to be supplied to the source device's hot-plug line.

In a further preferred embodiment, a conduction start voltage of the Zener diode is determined based on resistance values of the first resistor and the second resistor, a voltage supplied to the data communication line, and a voltage supplied to the power supply voltage line.

Another object of the present invention is to provide a hot-plug signal input/output apparatus that prevents a hot-plug signal from being supplied to a source device's hot-plug line when a hot-plug line of the apparatus is conducted to the source device's hot-plug line, a DDC line of the apparatus is conducted to a source device's DDC line, and a 5V power supply line of the apparatus is not conducted to a source device's 5V power supply line.

A hot-plug signal input/output apparatus as a preferred embodiment of the present invention that accepts as input a hot-plug signal from a sink device having a sink device's hot-plug line, a sink device's data communication line, and a sink device's power supply voltage line, and outputs the hot-plug signal to a source device having a source device's hot-plug line, a source device's data communication line, and a source device's power supply voltage line, the apparatus comprising: a hot-plug line that can be connected to the source device's hot-plug line and the sink device's hot-plug line; a data communication line that can be connected to the source device's data communication line and the sink device's data communication line; a power supply voltage line that is connected to the data communication line and that can be connected to the source device's power supply voltage line and the sink device's power supply voltage line; a power supply unit that supplies a power supply voltage to the sink device's power supply voltage line through the power supply voltage line; and output control section for detecting, when the hot-plug line is conducted to the source device's hot-plug line, the data communication line is conducted to the source device's data communication line, and the power supply voltage line is not conducted to the source device's power supply voltage line, that a voltage is not supplied from the source device's power supply voltage line to the power supply voltage line and a voltage is supplied from the source device's data communication line to the data communication line, whereby a power supply voltage is inhibited from being supplied from the power supply unit to the sink device's power supply voltage line; and detecting, when the hot-plug line is conducted to the source device's hot-plug line, the data communication line is conducted to the source device's data communication line, and the power supply voltage line is conducted to the source device's power supply voltage line, that a voltage is supplied from the source device's power supply voltage line to the power supply voltage line, whereby a power supply voltage is allowed to be supplied from the power supply unit to the sink device's power supply voltage line.

When the hot-plug line is conducted to the source device's hot-plug line, the data communication line is conducted to the source device's data communication line, and the power supply voltage line is not conducted to the source device's power supply voltage line, the power supply unit is prevented from supplying a power supply voltage to the sink device's power supply voltage line through the power supply voltage line based on a voltage supplied from the source device's data communication line to the data communication line. Accordingly, the sink device is prevented from outputting a hot-plug signal to the hot-plug line based on a power supply voltage supplied to the sink device's power supply voltage line and the hot-plug signal input/output apparatus is prevented from outputting a hot-plug signal supplied from the sink device, to the source device's hot-plug line. As a result, the source device is prevented from mistakenly detecting a hot-plug signal.

In a further preferred embodiment, the power supply voltage line is connected to the data communication line through a first resistor, the output control section includes a switching element that has a first electrode connected to the power supply unit and that controls the power supply unit; and a second resistor connected to a second electrode of the switching element, and when a voltage is not supplied from the source device's power supply voltage line to the power supply voltage line and a voltage is supplied from the source device's data communication line to the data communication line, a voltage which is obtained by dividing the voltage supplied to the data communication line by the first resistor and the second resistor is supplied to the second electrode and thus the switching element goes into an off state, whereby a power supply voltage is inhibited from being supplied from the power supply unit to the sink device's power supply voltage line; and when a voltage is supplied from the source device's power supply voltage line to the power supply voltage line, the voltage supplied to the power supply voltage line is supplied to the second electrode and thus the switching element goes into an on state, whereby a power supply voltage is allowed to be supplied from the power supply unit to the sink device's power supply voltage line.

When the hot-plug line is conducted to the source device's hot-plug line, the data communication line is conducted to the source device's data communication line, and the power supply voltage line is not conducted to the source device's power supply voltage line, a voltage supplied from the source device's data communication line to the data communication line is divided by the first resistor and the second resistor and a divided voltage is supplied to the second electrode of the switching element, and thus the switching element goes into an off state. By the switching element going into an off state, the power supply unit can be controlled not to supply a power supply voltage to the sink device's power supply voltage line.

In a further preferred embodiment, each of the hot-plug line, the data communication line, and the power supply voltage line is provided in plural number, in the output control section, the switching element and the second resistor are provided for each of a plurality of the power supply voltage lines, and the hot-plug signal input/output apparatus further comprises: selection section for selecting one hot-plug line, one data communication line, and one power supply voltage line from among a plurality of the hot-plug lines, the data communication lines, and the power supply voltage lines; and control section for supplying a control signal to a control electrode of only a switching element that is connected to the power supply voltage line selected by the selection section, the control signal being able to control the switching element to go into an on state.

Since a control signal is not supplied to a control electrode of a switching element connected to a power supply voltage line that is not selected by the selection section, even when the source device's power supply voltage line is conducted to the power supply voltage line, the switching element does not go into an on state. Accordingly, a hot-plug signal can be prevented from being outputted to a source device that is connected to a hot-plug line, a data communication line, and a power supply voltage line that are not selected by the selection section.

In a further preferred embodiment, the power supply voltage line is connected to the data communication line through a first resistor, the output control section includes a switching element that has a first electrode connected to the power supply unit and that controls the power supply unit; and a second resistor connected to a control electrode of the switching element and the power supply voltage line, and when a voltage is not supplied from the source device's power supply voltage line to the power supply voltage line and a voltage is supplied from the source device's data communication line to the data communication line, a voltage which is obtained by dividing the voltage supplied to the data communication line by the first resistor and the second resistor is supplied to the control electrode and thus the switching element goes into an off state, whereby a power supply voltage is inhibited from being supplied from the power supply unit to the sink device's power supply voltage line; and when a voltage is supplied from the source device's power supply voltage line to the power supply voltage line, the voltage supplied to the power supply voltage line is supplied to the control electrode and thus the switching element goes into an on state, whereby a power supply voltage is allowed to be supplied from the power supply unit to the sink device's power supply voltage line.

When the hot-plug line is conducted to the source device's hot-plug line, the data communication line is conducted to the source device's data communication line, and the power supply voltage line is not conducted to the source device's power supply voltage line, a voltage supplied from the source device's data communication line to the data communication line is divided by the first resistor and the second resistor and a divided voltage is supplied to the control electrode of the switching element, and thus the switching element goes into an off state. By the switching element going into an off state, the power supply unit can be controlled not to supply a power supply voltage to the sink device's power supply voltage line.

### BRIEF DESCRIPTION OF THE DRAWINGS

FIG. 1 is a block diagram showing an AV amplifier 10;

FIG. 2 is a block diagram showing a DVD player 20;

FIG. 3 is a circuit diagram showing a hot-plug signal output circuit 16 according to a preferred embodiment of the present invention;

FIG. 4 is a circuit diagram showing a hot-plug signal output circuit 26 according to another embodiment;

FIG. 5 is a block diagram showing an AV system according to the preferred embodiment of the present invention;

FIG. 6 is a block diagram showing an AV amplifier 10 according to the preferred embodiment of the present invention;

FIG. 7 is a block diagram showing a DVD player 20;

FIG. 8 is a block diagram showing a display apparatus 30;

FIG. 9 is a block diagram showing an AV system according to another preferred embodiment of the present invention;

FIG. 10 is a block diagram showing an AV amplifier 10B according to another preferred embodiment of the present invention;

FIG. 11 is a circuit diagram showing a conventional hot-plug signal output unit 66;

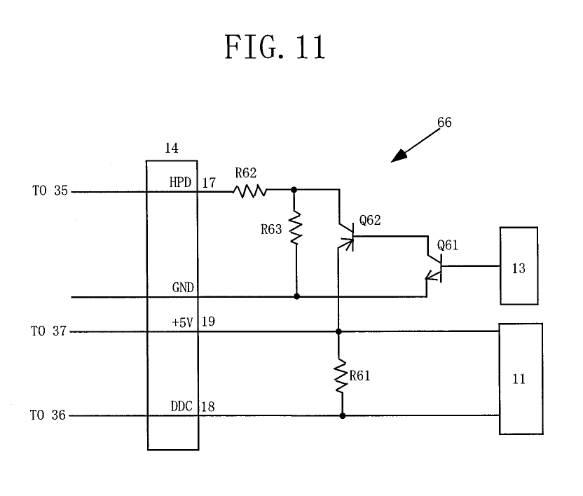

FIG. 12 is a circuit diagram showing a conventional hot-plug signal output unit 86; and

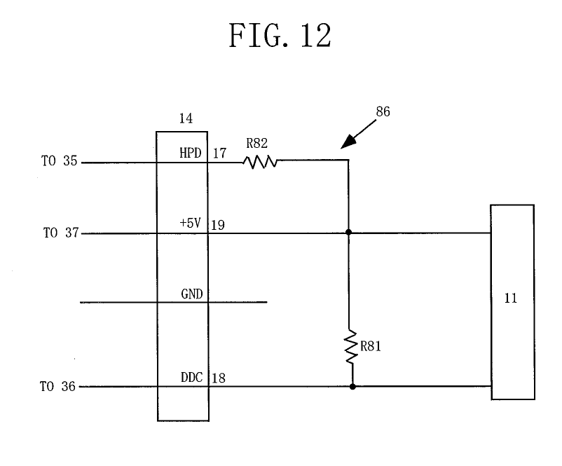

FIG. 13 is a block diagram showing a conventional AV amplifier 50.

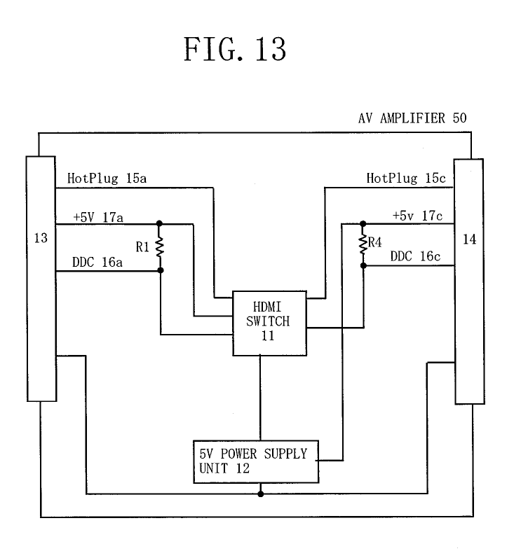

### DETAILED DESCRIPTION OF THE PREFERRED EMBODIMENTS

### The Preferred Embodiment 1

A content receiving apparatus including a hot-plug signal output apparatus according to a preferred embodiment of the present invention will be described below. The content receiving apparatus is a device that receives content data (video data and/or audio data) from a source device such as a DVD player or a blu-ray disc player, and is a repeater device such as an AV amplifier or an AV receiver, or a sink device such as a display apparatus or a projector.

### (Configuration of an AV Amplifier 10)

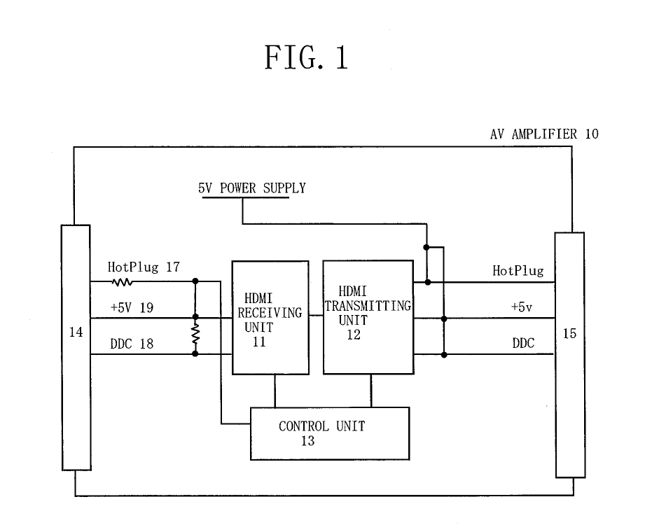

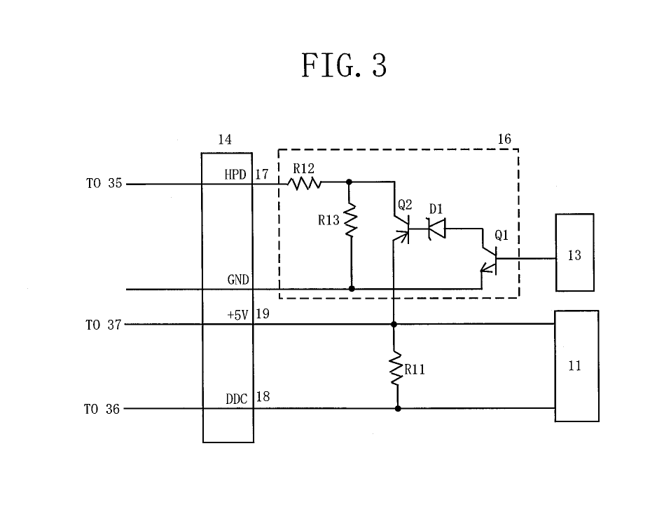

FIG. 1 is a schematic block diagram describing a main part of an AV amplifier 10. The AV amplifier 10 is a device that complies with an HDMI (High-Definition Multimedia Interface) standard and is called a repeater device. The AV amplifier 10 includes an HDMI receiving unit 11, an HDMI transmitting unit 12, a control unit 13, connectors 14 and 15, and a hot-plug signal output circuit 16 (see FIG. 3). To the connector 14 is connected, for example, a DVD player 20 which is a source device through an HDMI cable. To the connector 15 is connected, for example, a display apparatus (not shown) which is a sink device through an HDMI cable.

The AV amplifier 10 includes, as HDMI lines, a hot-plug line 17, a DDC line (data communication line) 18, a TMDS line (not shown), and a 5V power supply line (power supply voltage line) 19. The hot-plug line 17 can be connected to a hot-plug line 35 of the DVD player 20 through a hot-plug line of an HDMI cable. The DDC line 18 can be connected to a DDC line 36 of the DVD player 20 through a DDC line of the HDMI cable. The 5V power supply line 19 can be connected to a 5V power supply line 37 of the DVD player 20 through a 5V power supply line of the HDMI cable.

The hot-plug line 17 is used to output a hot-plug signal for notifying the DVD player 20 from the AV amplifier 10 of, for example, a fact that the AV amplifier 10 is connected to the DVD player 20 or a switching of a selector circuit of the AV amplifier 10. When a hot-plug signal from the AV amplifier 10 is at a low level, the DVD player 20 determines that the AV amplifier 10 is not active (“active” indicates a state of being able to receive and process HDMI data) or the AV amplifier 10 is not connected thereto; and when the hot-plug signal is at a high level, the DVD player 20 determines that the AV amplifier 10 is connected thereto.

The DDC (Display Data Channel) line 18 is used to obtain, by the DVD player 20, information (authentication information and EDID (Extended Display Identification Data) about the AV amplifier 10 from the AV amplifier 10.

The TMDS (Transition Minimized Differential Signaling) line is used to transmit HDMI standard compliant content data (hereinafter, referred to as HDMI data) from the DVD player 20 to the AV amplifier 10.

To the 5V power supply line 19, a 5V power supply voltage is supplied from a power supply circuit (not shown) of the AV amplifier 10, or a 5V power supply voltage is supplied from the 5V power supply line 37 of the DVD player 20. The 5V power supply line 19 is connected to the hot-plug line 17 through a switching section which will be described later, and to the DDC line 18 through a resistor R11 which will be described later. The 5V power supply line 19 supplies a 5V power supply voltage to the hot-plug line 17 and the DDC line 18.

The control unit 13 controls each unit of the AV amplifier 10 and is a microcomputer, a CPU, or the like.

The HDMI receiving unit 11 receives HDMI data transmitted from the DVD player 20. The HDMI receiving unit 11 also generates original video data (video data before being HDMI converted) from the received HDMI data and supplies the video data to the HDMI transmitting unit 12. The HDMI receiving unit 11 also generates original audio data from the received HDMI data and supplies the audio data to an audio processing unit (not shown).

The HDMI transmitting unit 12 converts the video data supplied from the HDMI receiving unit 11 and, as required, the audio data supplied from the audio processing unit (not shown) into HDMI data. The HDMI transmitting unit 12 transmits the HDMI data to a display apparatus (not shown) through the connector 15.

### (Configuration of the DVD Player 20)

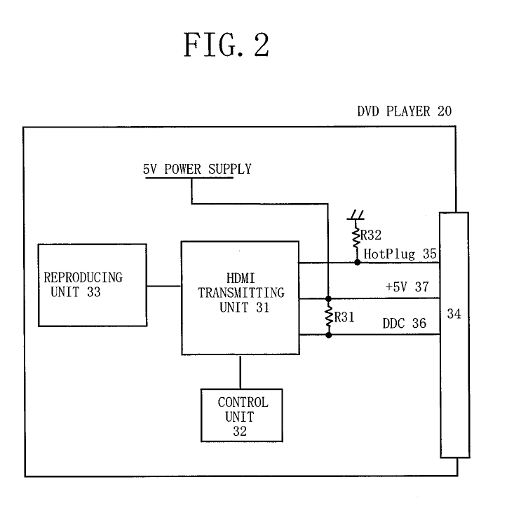

FIG. 2 is a schematic block diagram describing a main part of the DVD player 20. The DVD player 20 is a device that complies with the HDMI standard and is called a source device. The DVD player 20 includes an HDMI transmitting unit 31, a control unit 32, a reproducing unit 33, and a connector 34. To the connector 34 is connected, for example, an AV amplifier 10 through an HDMI cable.

Also, the DVD player 20 includes a hot-plug line (source device's hot-plug line) 35, a DDC line (source device's data communication line) 36, and a 5V power supply line (source device's power supply voltage line) 37. The 5V power supply line 37 is connected to the DDC line 36 through a resistor R31 and the hot-plug line 35 is connected to a ground potential through a resistor R32. To the 5V power supply line 37, a 5V power supply voltage is supplied from a power supply circuit (not shown) and the 5V power supply voltage is supplied to the DDC line 36 through the resistor R31.

The reproducing unit 33 reads video data and audio data recorded on a DVD disc (hereinafter, simply referred to as a disc) from the disc and supplies the video data and the audio data to the HDMI transmitting unit 31. The HDMI transmitting unit 31 converts the video and audio data supplied from the reproducing unit 33 into HDMI standard data (hereinafter, referred to as HDMI data) and transmits the HDMI data to the AV amplifier 10 through the connector 34.

### (Configuration of the Hot-Plug Signal Output Circuit 16)

FIG. 3 is a circuit diagram showing the hot-plug signal output circuit 16 of the AV amplifier 10. The hot-plug signal output circuit 16 includes a transistor Q1, a transistor (switching section) Q2, resistors R12 and R13, and a Zener diode D1. To a base of the transistor Q1, a high-level or low-level control signal is supplied from the control unit 13. An emitter of the transistor Q1 is connected to a ground potential and a collector of the transistor Q1 is connected to an anode of the Zener diode D1. Namely, by the transistor Q1 going into an on state, the anode potential of the Zener diode D1 is controlled to be connected to the ground potential.

A base of the transistor Q2 is connected to a cathode of the Zener diode D1, an emitter of the transistor Q2 is connected to the 5V power supply line 19 and one end of a resistor R11, and a collector of the transistor Q2 is connected to the respective one ends of the resistors R12 and R13. The other end of the resistor R12 is connected to the hot-plug line 17 and the other end of the resistor R13 is connected to a ground potential. Note that the resistor R11 supplies a 5V power supply voltage supplied from the 5V power supply line 19 to the DDC line 18, and the other end of the resistor R11 is connected to the DDC line 18.

The hot-plug signal output circuit 16 includes output control section. The output control section detects, when the hot-plug line 17 of the AV amplifier 10 is conducted (electrically connected) to the hot-plug line 35 of the DVD player 20, the DDC line 18 of the AV amplifier 10 is conducted to the DDC line 36 of the DVD player 20, and the 5V power supply line 19 of the AV amplifier 10 is not conducted to the 5V power supply line 37 of the DVD player 20, that a voltage is not supplied from the 5V power supply line 37 of the DVD player 20 to the 5V power supply line 19 of the AV amplifier 10 and that a voltage is supplied from the DDC line 36 of the DVD player 20 to the DDC line 18 of the AV amplifier 10, and thus brings the switching section into an open state, whereby the voltage supplied from the DDC line 36 of the DVD player 20 to the DDC line 18 of the AV amplifier 10 is inhibited from being supplied from the hot-plug line 17 of the AV amplifier 10 to the hot-plug line 35 of the DVD player 20.

Also, the output control section detects, when the hot-plug line 17 of the AV amplifier 10 is conducted to the hot-plug line 35 of the DVD player 20, the DDC line 18 of the AV amplifier 10 is conducted to the DDC line 36 of the DVD player 20, and the 5V power supply line 19 of the AV amplifier 10 is conducted to the 5V power supply line 37 of the DVD player 20, that a voltage is supplied from the 5V power supply line 37 of the DVD player 20 to the 5V power supply line 19 of the AV amplifier 10, and thus brings the switching section into a conduction (closing) state, whereby a high-level hot-plug signal is allowed to be supplied from the hot-plug line 17 of the AV amplifier 10 to the hot-plug line 35 of the DVD player 20.

The output control section includes the transistor Q2 and the Zener diode D1. When a voltage is not supplied from the 5V power supply line 19 but is supplied from the DDC line 18, the transistor Q2 goes into an off state and accordingly a path from the DDC line 18 to the hot-plug line 17 is disconnected, whereby the voltage from the DDC line 18 is inhibited from being outputted to the hot-plug line 35 of the DVD player 20. On the other hand, when a voltage is supplied from the 5V power supply line 19, the transistor Q2 goes into an on state and accordingly a path from the 5V power supply line 19 to the hot-plug line 17 is formed, whereby the voltage from the 5V power supply line is outputted to the hot-plug line 35 as a high-level hot-plug signal.

Specifically, in the Zener diode D1, when a cathode potential relative to an anode potential (ground potential) is less than a conduction start voltage (Zener voltage, e.g., 3.6V), a current does not flow through the anode from the cathode (i.e., the Zener diode D1 does not go into an on state), and in the transistor Q2 a current does not flow through the base from the emitter and thus the transistor Q2 goes into an off state. On the other hand, when the cathode potential relative to the anode potential is equal to or higher than the conduction start voltage, a current flows through the anode from the cathode (i.e., the Zener diode D1 goes into an on state), and in the transistor Q2 a current flows through the base from the emitter and thus the transistor Q2 goes into an on state.

Therefore, a condition for bringing the transistor Q2 into an on state is that the emitter potential of the transistor Q2 becomes equal to or higher than a voltage (4.2V) obtained by adding a conduction start voltage (e.g., 0.6V) of the transistor Q2 to the conduction start voltage (3.6V) of the Zener diode D1.

Here, assuming that a voltage from the DDC line 18 is supplied to the hot-plug line 35 through the hot-plug line 17, since the voltage from the DDC line 18 is divided by the resistors R11, R12, and R32, a voltage of about 1 to 2V is supplied to the hot-plug line 35 and a voltage of about 3 to 4V is supplied to the emitter of the transistor Q2. Hence, since the emitter potential of the transistor Q2 does not satisfy the condition (4.2V or higher) for bringing the transistor Q2 into an on state, the transistor Q2 goes into an off state. As a result, the voltage from the DDC line 18 is inhibited from being supplied to the hot-plug line 35.

When a voltage from the 5V power supply line 19 is supplied, since the emitter potential of the transistor Q2 is about 5V, the condition (4.2V or higher) for bringing the transistor Q2 into an on state is satisfied and thus the transistor Q2 goes into an on state.

That is, the conduction start voltage (Zener voltage) of the Zener diode D1 is set to a value that satisfies a condition such as that described above, based on the resistance values of the resistors R11, R12, and R32 and 5V voltages supplied to the DDC line 18 and the 5V power supply line 19.

### (Operation of a Hot-Plug Signal Output Apparatus)

The operation of a hot-plug signal output apparatus having the above-described configuration will be described.

First, a case will be described in which due to an HDMI cable being in the process of being connected to the connector 14 or 34 or due to insufficient connection of an HDMI cable to the connector 14 or 34, the hot-plug line 17 of the AV amplifier 10 is conducted to the hot-plug line 35 of the DVD player 20, the DDC line 18 of the AV amplifier 10 is conducted to the DDC line 36 of the DVD player 20, and the 5V power supply line 19 of the AV amplifier 10 is not conducted to the 5V power supply line 37 of the DVD player 20.

Since the 5V power supply line 19 of the AV amplifier 10 is not conducted to the 5V power supply line 37 of the DVD player 20, a 5V power supply voltage is not supplied from the 5V power supply line 37 of the DVD player 20 to the 5V power supply line 19 of the AV amplifier 10. Therefore, the transistor Q2 going into an on state by a voltage from the 5V power supply line 19 does not occur.

On the other hand, since the DDC line 18 of the AV amplifier 10 is conducted to the DDC line 36 of the DVD player 20, a 5V power supply voltage is supplied from the DDC line 36 of the DVD player 20 to the DDC line 18 of the AV amplifier 10. The control unit 13 supplies a high-level control signal to the base of the transistor Q1. When the high-level control signal is supplied to the base of the transistor Q1, the transistor Q1 goes into an on state and thus the anode of the Zener diode D1 goes into a state of being connected to the ground potential.

When the 5V power supply voltage from the DDC line 18 is supplied to the hot-plug line 35 through the hot-plug line 17, the 5V power supply voltage is, as described above, divided by the resistors R11, R12, and R32.

As a result, since the emitter potential of the transistor Q2 is about 3 to 4V, the cathode potential of the Zener diode D1 is about 2.4 to 3.4V which is obtained by subtracting a conduction start voltage of 0.6V of the transistor Q2, and thus is less than a conduction start voltage 3.6V of the Zener diode D1; accordingly, the Zener diode D1 goes into an off state and thus a current does not flow through the anode from the cathode. Hence, in the transistor Q2, a current does not flow through the base from the emitter and thus the transistor Q2 goes into an off state. As a result, due to the transistor Q2 going into an off state and disconnecting a path to the hot-plug line 17, the voltage from the DDC line 18 is inhibited from being supplied to the hot-plug line 35 of the DVD player 20. Accordingly, it is possible to prevent the DVD player 20 from misdetecting that the hot-plug signal has become a high level.

Next, a case will be described in which the hot-plug line 17 of the AV amplifier 10 is conducted to the hot-plug line 35 of the DVD player 20, the DDC line 18 of the AV amplifier 10 is conducted to the DDC line 36 of the DVD player 20, and the 5V power supply line 19 of the AV amplifier 10 is conducted to the 5V power supply line 37 of the DVD player 20.

Since the 5V power supply line 37 of the DVD player 20 is conducted to the 5V power supply line 19 of the AV amplifier 10, a 5V power supply voltage is supplied from the 5V power supply line 37 of the DVD player 20 to the 5V power supply line 19 of the AV amplifier 10. As a result, the emitter potential of the transistor Q2 is about 5V. The cathode potential of the Zener diode D1 is about 4.4V which is obtained by subtracting a conduction start voltage 0.6V of the transistor Q2, and thus is equal to or higher than a conduction start voltage 3.6V of the Zener diode D1; accordingly, the Zener diode D1 goes into an on state and thus a current flows through the anode from the cathode. As a result, a current flows through the base from the emitter of the transistor Q2 and accordingly the transistor Q2 goes into an on state.

Hence, the 5V power supply voltage from the 5V power supply line 19 is supplied, as a high-level hot-plug signal, to the hot-plug line 35 of the DVD player 20 through the transistor Q2, the resistor R12, and the hot-plug line 17. Based on the voltage supplied to the hot-plug line 35, the DVD player 20 can detect that the hot-plug signal has become a high level.

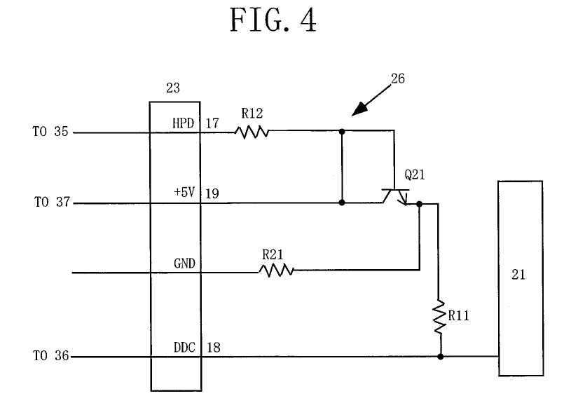

FIG. 4 is a circuit diagram showing a hot-plug signal output circuit 26 according to another embodiment. The hot-plug signal output circuit 26 includes a transistor Q21 (switching section) and resistors R12 and R21. By the transistor Q21 going into an on state when a voltage from the 5V power supply line 19 is supplied to a base thereof, a hot-plug signal is allowed to be supplied to the hot-plug line 35 of the DVD player 20 through the hot-plug line 17. By the transistor Q21 going into an off state when a voltage from the 5V power supply line 19 is not supplied to the base thereof, a voltage supplied from the DDC line 18 is inhibited from being supplied to the hot-plug line 35 of the DVD player 20 through the hot-plug line 17. The base of the transistor Q21 is connected to a collector thereof, the 5V power supply line 19, and one end of the resistor R12, and an emitter of the transistor Q21 is connected to a ground potential through the resistor R21 and to the DDC line 18 through a resistor R11.

The operation of the hot-plug signal output circuit 26 will be described below.

First, the case will be described in which the hot-plug line 17 of the AV amplifier 10 is conducted to the hot-plug line 35 of the DVD player 20, the DDC line 18 of the AV amplifier 10 is conducted to the DDC line 36 of the DVD player 20, and the 5V power supply line 19 of the AV amplifier 10 is not conducted to the 5V power supply line 37 of the DVD player 20.

Since the 5V power supply line 19 of the AV amplifier 10 is not conducted to the 5V power supply line 37 of the DVD player 20, a 5V power supply voltage is not supplied from the 5V power supply line 19 to the base of the transistor Q21 and thus the transistor Q21 is in an off state. Since the DDC line 18 of the AV amplifier 10 is conducted to the DDC line 36 of the DVD player 20, a 5V power supply voltage is supplied from the DDC line 36 to the DDC line 18. However, the voltage supplied to the DDC line 18 is interrupted because the transistor Q21 is in an off state and thus is not supplied to the hot-plug line 35 of the DVD player 20 through the hot-plug line 17. Hence, when the 5V power supply lines are not conducted, it is possible to prevent a voltage from the DDC line 18 from being supplied to the hot-plug line 35 and the DVD player 20 from misdetecting that a high-level hot-plug signal has been supplied thereto.

Next, the case will be described in which the hot-plug line 17 of the AV amplifier 10 is conducted to the hot-plug line 35 of the DVD player 20, the DDC line 18 of the AV amplifier 10 is conducted to the DDC line 36 of the DVD player 20, and the 5V power supply line 19 of the AV amplifier 10 is conducted to the 5V power supply line 37 of the DVD player 20.

Since the 5V power supply line 19 of the AV amplifier 10 is conducted to the 5V power supply line 37 of the DVD player 20, a 5V power supply voltage from the 5V power supply line 37 of the DVD player 20 is supplied to the 5V power supply line 19 of the AV amplifier 10. Hence, the 5V power supply voltage is supplied from the 5V power supply line 19 to the base of the transistor Q21 and accordingly the transistor Q21 goes into an on state. Then, the 5V power supply voltage from the 5V power supply line 19 is supplied, as a high-level hot-plug signal, to the hot-plug line 35 of the DVD player 20 through the resistor R12 and the hot-plug line 17. Thus, the DVD player 20 detects the high-level hot-plug signal and can thereby recognize that the AV amplifier 10 has been connected thereto.

As described above, according to the present invention, since a voltage from the DDC line 18 is inhibited from being supplied to the hot-plug line 35 of the DVD player 20 when the 5V power supply line 19 of the AV amplifier 10 is not conducted to the 5V power supply line 37 of the DVD player 20, it is possible to prevent the DVD player 20 from misdetecting when the AV amplifier 10 is not connected to the DVD player 20 that a high-level hot-plug signal has been supplied thereto.

Although the preferred embodiment of the present invention is described above, the present invention is not limited thereto. For example, the hot-plug signal output apparatus of the present invention can be applied not only to a repeater device but also to a sink device or a pass-through device. The pass-through device is a device that transfers HDMI data received from a source device, as it is to a sink device. In a case of a sink device, the sink device does not include an HDMI transmitting unit 12 but includes only an HDMI receiving unit 11. In a case of a pass-through device, the pass-through device includes a selector circuit (switcher) instead of an HDMI receiving unit 11 and an HDMI transmitting unit 12. The selector circuit selects, when a plurality of connectors 14 are provided and a plurality of DVD players are connected to an AV amplifier, HDMI data transmitted from one of the DVD players and outputs the HDMI data to a sink device. When, in the circuit in FIG. 3, the resistor R12 is not provided, a voltage from the DDC line 18 is divided by the resistors R11 and R32, and thus, the conduction start voltage of a Zener diode may be set based on the resistance values of the resistors R11 and R32. The hot-plug signal output apparatus of the present invention can be applied not only to an HDMI-standard device but also to any device complying with a DVI standard, etc., which are compatible with the HDMI standard.

### The Preferred Embodiment 2

A content transmitting/receiving apparatus having a function as a hot-plug signal input/output apparatus according to a preferred embodiment of the present invention will be described below. The content transmitting/receiving apparatus is a device that receives content data (HDMI standard compliant video data and/or audio data; hereinafter, referred to as HDMI data) from a source device such as a DVD player or a blu-ray disc player, and transmits the HDMI data to a sink device such as a display apparatus or a projector, and is an AV amplifier or an AV receiver. Alternatively, the content transmitting/receiving apparatus is an HDMI switcher, a pass-through device, or the like. A case in which the content transmitting/receiving apparatus is an AV amplifier 10 will be described below as an example.

### (Overall Configuration)

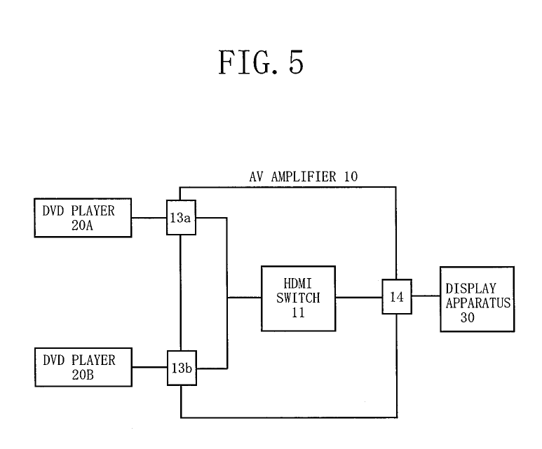

FIG. 5 is a block diagram showing an overall configuration of an AV system. The AV system includes an AV amplifier (HDMI switcher) 10, DVD players 20A and 20B, and a display apparatus 30, which are connected to each other through HDMI cables. The DVD player 20A is connected to a connector (input terminal) 13a of the AV amplifier 10, the DVD player 20B is connected to a connector (input terminal) 13b of the AV amplifier 10, and the display apparatus 30 is connected to a connector (output terminal) 14 of the AV amplifier 10. An HDMI switch 11 selects one HDMI data unit from among HDMI data units supplied from the DVD players 20A and 20B and supplies the HDMI data unit to the display apparatus 30.

### (Configuration of the AV Amplifier (HDMI Switcher) 10)

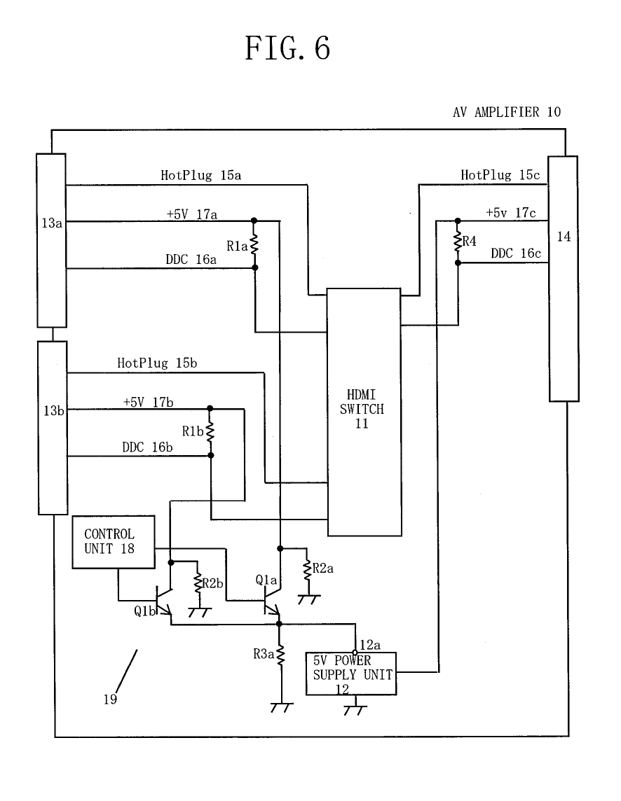

FIG. 6 is a block diagram describing the AV amplifier 10. The AV amplifier 10 is a device that complies with the HDMI (High-Definition Multimedia Interface) standard. The AV amplifier 10 includes an HDMI switch 11, a 5V power supply unit 12, a plurality of connectors 13 (e.g., connectors 13a and 13b), a connector 14, a control unit 18, and an output control section 19.

The AV amplifier 10 includes, as HDMI lines, hot-plug lines 15a to 15c, DDC lines (data communication lines) 16a to 16c, TMDS lines (not shown), and 5V power supply lines (power supply voltage lines) 17a to 17c. The hot-plug lines 15a and 15b can be connected to respective hot-plug lines 25 of DVD players 20 through respective hot-plug lines of HDMI cables. The hot-plug line 15c can be connected to a hot-plug line 35 of a display apparatus 30 through a hot-plug line of an HDMI cable. The DDC lines 16a and 16b can be connected to respective DDC lines 26 of the DVD players 20 through respective DDC lines of the HDMI cables. The DDC line 16c can be connected to a DDC line 36 of the display apparatus 30 through a DDC line of the HDMI cable. The 5V power supply lines 17a and 17b can be connected to respective 5V power supply lines 27 of the DVD players 20 through respective 5V power supply lines of the HDMI cables. The 5V power supply line 17c can be connected to a 5V power supply line 37 of the display apparatus 30 through a 5V power supply line of the HDMI cable.

Each of the hot-plug lines 15a and 15b is used to output a hot-plug signal for notifying a corresponding DVD player 20 from the AV amplifier 10 of the fact that the AV amplifier 10 is connected to the DVD player 20. When a hot-plug signal from the AV amplifier 10 is at a low level, the DVD players 20 determine that the AV amplifier 10 is not active (“active” indicates a state of being able to receive and process HDMI data) or the AV amplifier 10 is not connected thereto; and when the hot-plug signal is at a high level, the DVD players 20 determine that the AV amplifier 10 is connected thereto. The hot-plug line 15c is used to receive a hot-plug signal for notifying the AV amplifier 10 from the display apparatus 30 of the fact that the display apparatus 30 is connected to the AV amplifier 10.

Each of the DDC (Display Data Channel) lines 16a and 16b is used to obtain, by a corresponding DVD player 20, information (authentication information and EDID (Extended Display Identification Data)) about the AV amplifier 10 and/or the display apparatus 30 from the AV amplifier 10. The DDC line 16c is used to obtain, by the AV amplifier 10, information (authentication information and EDID) about the display apparatus 30 from the display apparatus 30. Note that although a DDC line normally includes a data line and a clock line, for simplification of description, only one line is shown.

The TMDS (Transition Minimized Differential Signaling) lines are used to transmit HDMI data from the DVD players 20 to the AV amplifier 10 and from the AV amplifier 10 to the display apparatus 30.

To the 5V power supply lines 17a and 17b, a 5V power supply voltage is supplied from the 5V power supply lines 27 of their corresponding DVD players 20. The 5V power supply lines 17a and 17b are respectively connected to the DDC lines 16a and 16b through resistors R1a and R1b, and supply the 5V power supply voltage to the corresponding DDC lines 16a and 16b. To the 5V power supply line 17c, a 5V power supply voltage is supplied from the 5V power supply unit 12 and the 5V power supply line 17c supplies the 5V power supply voltage to the 5V power supply line 37 of the display apparatus 30.

The HDMI switch 11 receives HDMI data units transmitted from DVD players 20A and 20B connected to the connectors 13a and 13b, respectively, selects one of the received HDMI data units, and transmits the selected HDMI data unit to the display apparatus 30. In other words, the HDMI switch 11 selects one connector 13 and its hot-plug line 15, DDC line 16, and 5V power supply line 17 from among a plurality of connectors 13 and their respective hot-plug lines 15, DDC lines 16, and 5V power supply lines 17. The selection of HDMI data can be switched by an instruction from the control unit 18 based on a user operation.

The 5V power supply unit 12 is provided with a commercial alternating-current power supply (not shown) and supplies a 5V power supply voltage to the 5V power supply line 37 of the display apparatus 30 through the 5V power supply line 17c. The 5V power supply unit 12 has a control signal input terminal 12a. The 5V power supply unit 12 outputs a 5V power supply voltage to the 5V power supply line 37 when a high-level control signal is inputted to the control signal input unit 12a from the output control section 19 (transistors Q1a and Q1b) which will be described later, and does not output a 5V power supply voltage to the 5V power supply line 37 when a high-level control signal is not inputted to the control signal input unit 12a. That is, whether or not the 5V power supply unit 12 outputs a 5V power supply voltage is controlled by the output control section 19.

Note that when a 5V power supply voltage is supplied from the 5V power supply unit 12 to the 5V power supply line 37 of the display apparatus 30, a high-level hot-plug signal is supplied from the hot-plug line 35 of the display apparatus 30 to the hot-plug line 15c. When a 5V power supply voltage is not supplied from the 5V power supply unit 12 to the 5V power supply line 37 of the display apparatus 30, a high-level hot-plug signal is not supplied from the hot-plug line 35 of the display apparatus 30 to the hot-plug line 15c.

The control unit 18 controls each unit of the AV amplifier 10 and is a microcomputer, a CPU, or the like. The control unit 18 and the output control section 19 will be described in detail later.

### (Configuration of the DVD Player 20)

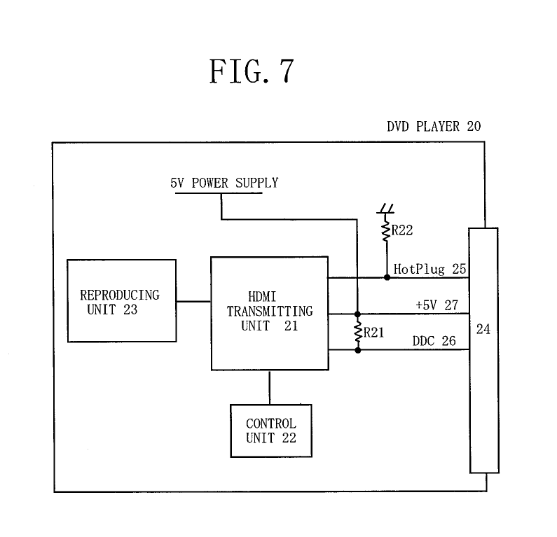

FIG. 7 is a block diagram describing the DVD player 20. The DVD player 20 is a device that complies with the HDMI standard and is called a source device. The DVD player 20 includes an HDMI transmitting unit 21, a control unit 22, a reproducing unit 23, and a connector 24. To the connector 24 is connected, for example, an AV amplifier 10 through an HDMI cable.

The DVD player 20 includes a hot-plug line (source device's hot-plug line) 25, a DDC line (source device's data communication line) 26, and a 5V power supply line (source device's power supply voltage line) 27. The 5V power supply line 27 is connected to the DDC line 26 through a resistor R21 and the hot-plug line 25 is connected to a ground potential through a resistor R22. To the 5V power supply line 27, a 5V power supply voltage is supplied from a power supply circuit (not shown) and the 5V power supply voltage is supplied to the DDC line 26 through the resistor R21.

The reproducing unit 23 reads video data and audio data recorded on a DVD disc (hereinafter, simply referred to as a disc) from the disc and supplies the video data and the audio data to the HDMI transmitting unit 21. The HDMI transmitting unit 21 converts the video and audio data supplied from the reproducing unit 23 into HDMI data and transmits the HDMI data to the AV amplifier 10 through the connector 24.

### (Configuration of the Display Apparatus 30)

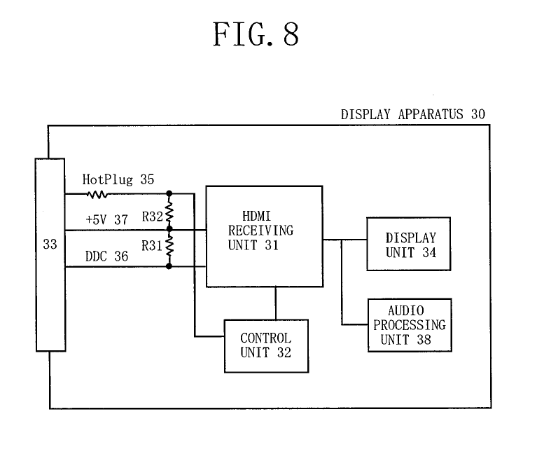

FIG. 8 is a block diagram describing the display apparatus 30. The display apparatus 30 is a device that complies with the HDMI standard and is called a sink device. The display apparatus 30 includes an HDMI receiving unit 31, a control unit 32, a connector 33, a display unit 34, and an audio processing unit 38. To the connector 33 is connected, for example, an AV amplifier 10 through an HDMI cable.

The display apparatus 30 includes a hot-plug line (sink device's hot-plug line) 35, a DDC line (sink device's data communication line) 36, and a 5V power supply line (sink device's power supply voltage line) 37. The 5V power supply line 37 is connected to the DDC line 36 through a resistor R31. To the 5V power supply line 37, a 5V power supply voltage is supplied from the 5V power supply line 17c of the AV amplifier 10, and the 5V power supply voltage is supplied to the DDC line 36 through the resistor R31. Also, the 5V power supply voltage supplied to the 5V power supply line 37 is outputted, as a high-level hot-plug signal, to the AV amplifier 10 through the hot-plug line 35.

The HDMI receiving unit 31 receives HDMI data transmitted from the AV amplifier 10. The HDMI receiving unit 31 generates original video data (video data before being HDMI converted) from the received HDMI data and supplies the video data to the display unit 34. The HDMI receiving unit 31 generates original audio data from the received HDMI data and supplies the audio data to the audio processing unit 38.

The display unit 34 displays the supplied video data and is an LCD, a PDP, or the like. The audio processing unit 38 performs a decoding process, a D/A conversion process, and an amplification process on the supplied audio data and supplies the processed audio data to a speaker (not shown).

### (Configuration of the Output Control Section 19)

With reference to FIG. 6, the output control section 19 will be described in detail below. Note that although only a portion corresponding to the connector 13a will be described herein, the same also applies to a portion corresponding to the connector 13b.

The output control section 19 detects, when the hot-plug line 15a of the AV amplifier 10 is conducted (electrically connected) to the hot-plug line 25 of the DVD player 20, the DDC line 16a of the AV amplifier 10 is conducted to the DDC line 26 of the DVD player 20, and the 5V power supply line 17a of the AV amplifier 10 is not conducted to the 5V power supply line 27 of the DVD player 20, that a voltage is not supplied from the 5V power supply line 27 of the DVD player 20 to the 5V power supply line 17a of the AV amplifier 10 and that a voltage is supplied from the DDC line 26 of the DVD player 20 to the DDC line 16c of the AV amplifier 10, and thus inhibits a 5V power supply voltage from the 5V power supply unit 12 from being supplied to the 5V power supply line 37 of the display apparatus 30 through the 5V power supply line 17c. That is, the output control section 19 controls the 5V power supply unit 12 to prohibit a high-level hot-plug signal from being inputted from the hot-plug line 35 of the display apparatus 30 and outputted to the hot-plug line 25 of the DVD player 20.

Moreover, the output control section 19 detects, when the hot-plug line 15a of the AV amplifier 10 is conducted to the hot-plug line 25 of the DVD player 20, the DDC line 16a of the AV amplifier 10 is conducted to the DDC line 26 of the DVD player 20, and the 5V power supply line 17a of the AV amplifier 10 is conducted to the 5V power supply line 27 of the DVD player 20, that a voltage is supplied from the 5V power supply line 27 of the DVD player 20 to the 5V power supply line 17a of the AV amplifier 10, and thus allows a 5V power supply voltage from the 5V power supply unit 12 from being supplied to the 5V power supply line 37 of the display apparatus 30 through the 5V power supply line 17c. That is, the output control section 19 controls the 5V power supply unit 12 to allow a high-level hot-plug signal to be inputted from the hot-plug line 35 of the display apparatus 30 and outputted to the hot-plug line 25 of the DVD player 20.

The output control section 19 includes a switching element (e.g., a transistor) Q1a and resistors R2a and R3a. The transistor Q1a switches whether or not to supply a high-level control signal to the control signal input terminal 12a of the 5V power supply unit 12. Specifically, when a 5V power supply voltage is not supplied from the 5V power supply line 27 of the DVD player 20 to the 5V power supply line 17a of the AV amplifier 10 and a 5V power supply voltage is supplied from the DDC line 26 of the DVD player 20 to the DDC line 16a of the AV amplifier 10, the transistor Q1a goes into an off state, whereby the 5V power supply unit 12 is controlled not to output a 5V power supply voltage. On the other hand, when a 5V power supply voltage is supplied from the 5V power supply line 27 of the DVD player 20 to the 5V power supply line 17a of the AV amplifier 10, the transistor Q1a goes into an on state, whereby the 5V power supply unit 12 is controlled to output a 5V power supply voltage.

A collector of the transistor Q1a is connected to the 5V power supply line 17a, to the DDC line 16a through the resistor R1a, and to a ground potential through the resistor R2a. An emitter of the transistor Q1a is connected to the control signal input terminal 12a of the 5V power supply unit 12 and to a ground potential through the resistor R3a. To a base of the transistor Q1a is inputted a high-level control signal from the control unit 18. Specifically, when either the connector 13a or 13b to which HDMI data to be received by the HDMI switch 11 is inputted is selected by a user operation through an operation unit (not shown), the control unit 18 outputs to the base of either the transistor Q1a or Q1b connected to the selected connector 13 a high-level (e.g., about 3.3V) control signal (which can control the transistor to go into an on state).

For a 5V power supply voltage supplied from the 5V power supply line 27 of the DVD player 20, the resistor R2a supplies the 5V power supply voltage as it is to the collector of the transistor Q1a. For a 5V power supply voltage supplied from the DDC line 26 of the DVD player 20, the resistor R2a together with the resistor R1a divides the 5V power supply voltage and supplies 5V×R2a/(R1a+R2a) to the collector of the transistor Q1a. For example, when the resistor R1a is 47 kΩ and the resistor R2a is 4.7 kΩ, of a 5V power supply voltage supplied from the DDC line 26 of the DVD player 20, about 0.45V is supplied to the collector of the transistor Q1a.

Hence, when a high-level control signal is supplied from the control unit 18 to the base and a 5V power supply voltage from the 5V power supply line 27 is supplied to the collector, the transistor Q1a goes into an on state. On the other hand, when a high-level control signal is not supplied from the control unit 18 to the base or when a voltage which is obtained by dividing a 5V power supply voltage from the DDC line 26 by the resistors R1a and R2a is supplied to the collector, the transistor Q1a goes into an off state.

The resistor R3a causes a current to flow between the collector and the emitter when the transistor Q1a goes into an on state, to generate a control signal (voltage) which is supplied to the control signal input terminal 12a of the 5V power supply unit 12.

### (Operation of the AV Amplifier 10)

Although the operation of the AV amplifier 10 having the above-described configuration will be described focusing on the connector 13a, the same also applies to the connector 13b.

(1) In a case where the connector 13a is selected by the HDMI switch 11, the hot-plug line 15a of the AV amplifier 10 is conducted to the hot-plug line 25 of the DVD player 20, the DDC line 16a of the AV amplifier 10 is conducted to the DDC line 26 of the DVD player 20, and the 5V power supply line 17a of the AV amplifier 10 is not conducted to the 5V power supply line 27 of the DVD player 20.

Since the 5V power supply line 17a of the AV amplifier 10 is not conducted to the 5V power supply line 27 of the DVD player 20, a 5V power supply voltage is not supplied from the 5V power supply line 27 of the DVD player 20 to the 5V power supply line 17a of the AV amplifier 10.

On the other hand, since the DDC line 16a of the AV amplifier 10 is conducted to the DDC line 26 of the DVD player 20, a 5V power supply voltage is supplied from the DDC line 26 of the DVD player 20 to the DDC line 16a of the AV amplifier 10. The 5V power supply voltage is divided by the resistors R1a and R2a and thus a divided voltage (e.g., 0.45V) is supplied to the collector of the transistor Q1a.

Since the connector 13a is selected by the HDMI switch 11, a high-level control signal (e.g., 3.3V) is supplied from the control unit 18 to the base of the transistor Q1a. As a result of the above, since the voltage supplied to the collector is as low as 0.45V, the transistor Q1a goes into an off state and thus a current does not flow through the emitter from the collector of the transistor Q1a and a high-level control signal is not inputted to the control signal input terminal 12a of the 5V power supply unit 12. Hence, the 5V power supply unit 12 does not supply a 5V power supply voltage to the 5V power supply line 37 of the display apparatus 30 through the 5V power supply line 17c. Accordingly, since a high-level hot-plug signal is not inputted from the hot-plug line 35 of the display apparatus 30 to the hot-plug line 15c, a high-level hot-plug signal is inhibited from being outputted from the hot-plug line 15a to the hot-plug line 25 of the DVD player 20.

(2) In a case where the connector 13a is not selected by the HDMI switch 11, the hot-plug line 15a of the AV amplifier 10 is conducted to the hot-plug line 25 of the DVD player 20, the DDC line 16a of the AV amplifier 10 is conducted to the DDC line 26 of the DVD player 20, and the 5V power supply line 17a of the AV amplifier 10 is conducted to the 5V power supply line 27 of the DVD player 20

Since the 5V power supply line 17a of the AV amplifier 10 is conducted to the 5V power supply line 27 of the DVD player 20, a 5V power supply voltage is supplied from the 5V power supply line 27 of the DVD player 20 to the 5V power supply line 17a of the AV amplifier 10. The 5V power supply voltage is supplied as it is to the collector of the transistor Q1a without being divided by the resistors R1a and R2a.

Since the connector 13a is not selected by the HDMI switch 11, a high-level control signal (e.g., 3.3V) is not supplied from the control unit 18 to the base of the transistor Q1a. As a result of the above, since the voltage between the base and the emitter is less than a conduction start voltage and thus the transistor Q1a goes into an off state, a current does not flow through the emitter from the collector of the transistor Q1a and a high-level control signal is not inputted to the control signal input terminal 12a of the 5V power supply unit 12. Hence, the 5V power supply unit 12 does not supply a 5V power supply voltage to the 5V power supply line 37 of the display apparatus 30 through the 5V power supply line 17c. Accordingly, since a high-level hot-plug signal is not inputted from the hot-plug line 35 of the display apparatus 30 to the hot-plug line 15c, a high-level hot-plug signal is inhibited from being outputted from the hot-plug line 15a to the hot-plug line 25 of the DVD player 20. Therefore, a high-level hot-plug signal is not outputted to the DVD player 20 connected to the connector 13a which is not selected by the HDMI switch 11.

(3) In a case where the connector 13a is not selected by the HDMI switch 11, the hot-plug line 15a of the AV amplifier 10 is conducted to the hot-plug line 25 of the DVD player 20, the DDC line 16a of the AV amplifier 10 is conducted to the DDC line 26 of the DVD player 20, and the 5V power supply line 17a of the AV amplifier 10 is not conducted to the 5V power supply line 27 of the DVD player 20.

Since the 5V power supply line 17a of the AV amplifier 10 is not conducted to the 5V power supply line 27 of the DVD player 20, a 5V power supply voltage is not supplied from the 5V power supply line 27 of the DVD player 20 to the 5V power supply line 17a of the AV amplifier 10.

On the other hand, since the DDC line 16a of the AV amplifier 10 is conducted to the DDC line 26 of the DVD player 20, a 5V power supply voltage is supplied from the DDC line 26 of the DVD player 20 to the DDC line 16a of the AV amplifier 10. The 5V power supply voltage is divided by the resistors R1a and R2a and thus a divided voltage (e.g., 0.45V) is supplied to the collector of the transistor Q1a.

Since the connector 13a is not selected by the HDMI switch 11, a high-level control signal (e.g., 3.3V) is not supplied from the control unit 18 to the base of the transistor Q1a. As a result of the above, since the transistor Q1a goes into an off state, a current does not flow through the emitter from the collector of the transistor Q1a and a high-level control signal is not inputted to the control signal input terminal 12a of the 5V power supply unit 12. Hence, the 5V power supply unit 12 does not supply a 5V power supply voltage to the 5V power supply line 37 of the display apparatus 30 through the 5V power supply line 17c. Accordingly, since a high-level hot-plug signal is not inputted from the hot-plug line 35 of the display apparatus 30 to the hot-plug line 15c, a high-level hot-plug signal is inhibited from being outputted from the hot-plug line 15a to the hot-plug line 25 of the DVD player 20.

(4) In a case where the connector 13a is selected by the HDMI switch 11, the hot-plug line 15a of the AV amplifier 10 is conducted to the hot-plug line 25 of the DVD player 20, the DDC line 16a of the AV amplifier 10 is conducted to the DDC line 26 of the DVD player 20, and the 5V power supply line 17a of the AV amplifier 10 is conducted to the 5V power supply line 27 of the DVD player 20.

Since the 5V power supply line 17a of the AV amplifier 10 is conducted to the 5V power supply line 27 of the DVD player 20, a 5V power supply voltage is supplied from the 5V power supply line 27 of the DVD player 20 to the 5V power supply line 17a of the AV amplifier 10. The 5V power supply voltage is supplied as it is to the collector of the transistor Q1a without being divided by the resistors R1a and R2a.

Since the connector 13a is selected by the HDMI switch 11, a high-level control signal (e.g., 3.3V) is supplied from the control unit 18 to the base of the transistor Q1a. As a result of the above, since the 5V power supply voltage is supplied to the collector and the voltage between the base and the emitter is equal to or higher than the conduction start voltage and thus the transistor Q1a goes into an on state, a current flows through the emitter from the collector of the transistor Q1a and a high-level control signal is inputted to the control signal input terminal 12a of the 5V power supply unit 12. The 5V power supply unit 12 supplies a 5V power supply voltage to the 5V power supply line 37 of the display apparatus 30 through the 5V power supply line 17c.

In the display apparatus 30, the 5V power supply voltage supplied to the 5V power supply line 37 is outputted, as a high-level hot-plug signal, to the hot-plug line 15c of the AV amplifier 10 through the hot-plug line 35. The high-level hot-plug signal inputted to the hot-plug line 15c is outputted to the hot-plug line 25 of the DVD player 20 through the HDMI switch 11 and the hot-plug line 15a. The HDMI transmitting unit 21 of the DVD player 20 detects the high-level hot-plug signal inputted to the hot-plug line 25 and can thereby determine that the AV amplifier 10 and the display apparatus 30 have been connected to the DVD player 20.

As described above, according to the present example, when the 5V power supply lines 17a and 27 are not conducted to each other, by the transistor Q1a going into an off state, a 5V power supply voltage is inhibited from being outputted from the 5V power supply unit 12 to the 5V power supply line 37 of the display apparatus 30 and thus a high-level hot-plug signal is inhibited from being outputted to the hot-plug line 25 of the DVD player 20.

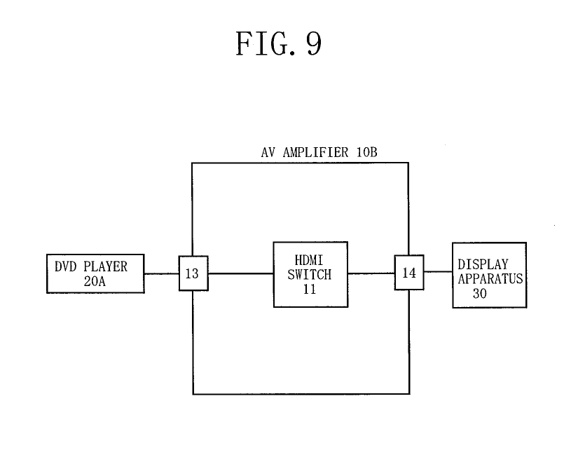

FIG. 9 is a block diagram showing an overall configuration of an AV system according to another embodiment. An AV amplifier 10B has only one connector 13 and the HDMI switch 11 transmits HDMI data received from a DVD player 20A, to a display apparatus 30. That is, the AV amplifier 10B is a pass-through device.

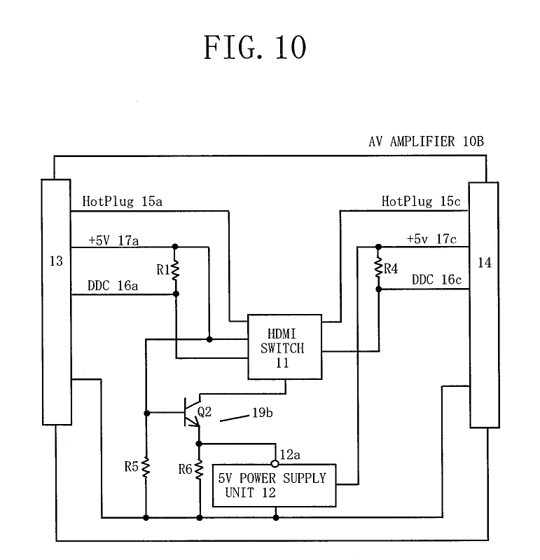

FIG. 10 is a block diagram showing the AV amplifier 10B. An output control section 19b includes a transistor Q2 and resistors R5 and R6. A collector of the transistor Q2 is connected to the HDMI switch 11. To the collector of the transistor Q2, a high-level control signal (voltage) for controlling a 5V power supply unit 12 is supplied from the HDMI switch 11. An emitter of the transistor Q2 is connected to a control signal input terminal 12a of the 5V power supply unit 12 and to a ground potential through the resistor R6. A base of the transistor Q2 is connected to a 5V power supply line 17a, to a DDC line 16a through a resistor R1, and to a ground potential through the resistor R5.

For a 5V power supply voltage supplied from the 5V power supply line 27 of the DVD player 20, the resistor R5 supplies the 5V power supply voltage as it is to the base of the transistor Q2. For a 5V power supply voltage supplied from the DDC line 26 of the DVD player 20, the resistor R5 together with the resistor R1 divides the 5V power supply voltage and supplies 5V×R5/(R1+R5) to the base of the transistor Q2. For example, when the resistor R1 is 47 kΩ and the resistor R5 is 4.7 kΩ, of a 5V power supply voltage supplied from the DDC line 26 of the DVD player 20, about 0.45V is supplied to the base of the transistor Q2.

Hence, when a 5V power supply voltage from the 5V power supply line 27 is supplied to the base, the voltage between the base and the emitter is equal to or higher than the conduction start voltage and thus the transistor Q2 goes into an on state. On the other hand, when a voltage which is obtained by dividing a 5V power supply voltage from the DDC line 26 by the resistors R1 and R5 is supplied to the base, the voltage between the base and the emitter is less than the conduction start voltage and thus the transistor Q2 goes into an off state.

### (Operation of the AV Amplifier 10B)

(1) In a case where a hot-plug line 15a of the AV amplifier 10B is conducted to the hot-plug line 25 of the DVD player 20, the DDC line 16a of the AV amplifier 10B is conducted to the DDC line 26 of the DVD player 20, and the 5V power supply line 17a of the AV amplifier 10B is not conducted to the 5V power supply line 27 of the DVD player 20.

Since the 5V power supply line 17a of the AV amplifier 10B is not conducted to the 5V power supply line 27 of the DVD player 20, a 5V power supply voltage is not supplied from the 5V power supply line 27 of the DVD player 20 to the 5V power supply line 17a of the AV amplifier 10B.

On the other hand, since the DDC line 16a of the AV amplifier 10B is conducted to the DDC line 26 of the DVD player 20, a 5V power supply voltage is supplied from the DDC line 26 of the DVD player 20 to the DDC line 16a of the AV amplifier 10B. Since the 5V power supply voltage is divided by the resistors R1 and R5, a divided voltage (e.g., 0.45V) is supplied to the base of the transistor Q2. As a result, since the transistor Q2 goes into an off state, a current does not flow through the emitter from the collector of the transistor Q2 and a high-level control signal is not inputted to the control signal input terminal 12a of the 5V power supply unit 12. Hence, the 5V power supply unit 12 does not supply a 5V power supply voltage to the 5V power supply line 37 of the display apparatus 30 through the 5V power supply line 17c. Accordingly, since a high-level hot-plug signal is not inputted from the hot-plug line 35 of the display apparatus 30 to the hot-plug line 15c, a high-level hot-plug signal is inhibited from being outputted from the hot-plug line 15a to the hot-plug line 25 of the DVD player 20.

(2) In a case where the hot-plug line 15a of the AV amplifier 10B is conducted to the hot-plug line 25 of the DVD player 20, the DDC line 16a of the AV amplifier 10B is conducted to the DDC line 26 of the DVD player 20, and the 5V power supply line 17a of the AV amplifier 10B is conducted to the 5V power supply line 27 of the DVD player 20.

Since the 5V power supply line 17a of the AV amplifier 10B is conducted to the 5V power supply line 27 of the DVD player 20, a 5V power supply voltage is supplied from the 5V power supply line 27 of the DVD player 20 to the 5V power supply line 17a of the AV amplifier 10B. The 5V power supply voltage is supplied as it is to the collector of the transistor Q2 without being divided by the resistors R1 and R5.

As a result, the transistor Q2 goes into an on state and thus a current flows through the emitter from the collector of the transistor Q2 and a high-level control signal is inputted to the control signal input terminal 12a of the 5V power supply unit 12. The 5V power supply unit 12 supplies a 5V power supply voltage to the 5V power supply line 37 of the display apparatus 30 through the 5V power supply line 17c.

In the display apparatus 30, the 5V power supply voltage supplied to the 5V power supply line 37 is outputted, as a high-level hot-plug signal, to the hot-plug line 15c of the AV amplifier 10B through the hot-plug line 35. The high-level hot-plug signal inputted to the hot-plug line 15c is outputted to the hot-plug line 25 of the DVD player 20 through the HDMI switch 11 and the hot-plug line 15a. The HDMI transmitting unit 21 of the DVD player 20 detects the high-level hot-plug signal inputted to the hot-plug line 25 and can thereby determine that the AV amplifier 10B and the display apparatus 30 have been connected to the DVD player 20.

As described above, according to the present example, when the 5V power supply lines 17a and 27 are not conducted to each other, by the transistor Q2 going into an off state, a 5V power supply voltage is inhibited from being outputted from the 5V power supply unit 12 to the 5V power supply line 37 of the display apparatus 30 and thus a high-level hot-plug signal is inhibited from being outputted to the hot-plug line 25 of the DVD player 20.

Although the preferred embodiment of the present invention is described above, the present invention is not limited thereto. For example, the configuration of a hot-plug signal output from the hot-plug line 35 of the display apparatus 30 is not limited to that described above; a 5V power supply voltage supplied to the 5V power supply line 37 may be temporarily supplied to the HDMI receiving unit 31 and after each process is performed, a high-level hot-plug signal may be outputted from the control unit 32 to the hot-plug line 15c of the AV amplifier 10 through the hot-plug line 35. The number of connectors of the AV amplifier 10 is not limited to that described above; for example, three connectors 13 and two connectors 14 may be provided. The switching element is not limited to a transistor and may be a MOSFET, and the like. The AV amplifier 10 may include an HDMI receiving unit and an HDMI transmitting unit, in addition to an HDMI switch. In this case, audio data contained in HDMI data can be amplified by the AV amplifier 10 and the amplified audio data can be outputted to a speaker. The AV amplifier 10 may receive audio data from the DVD player 20 not only through an HDMI cable but also through an optical digital cable, and the like. The AV amplifier 10 can be applied not only to an HDMI-standard device but also to any device complying with the DVI standard, and the like, which are compatible with the HDMI standard.

What is claimed is:

1. A hot-plug signal output apparatus that outputs a hot-plug signal to a source device having a source device's hot-plug line, a source device's data communication line, and a source device's power supply voltage line, the apparatus comprising:
a hot-plug line that can be connected to the source device's hot-plug line;
a data communication line that can be connected to the source device's data communication line;
a power supply voltage line that is connected to the data communication line and to the hot-plug line through switching section and that can be connected to the source device's power supply voltage line; and
output control section for detecting, when the hot-plug line is conducted to the source device's hot-plug line, the data communication line is conducted to the source device's data communication line, and the power supply voltage line is not conducted to the source device's power supply voltage line, that a voltage is not supplied from the source device's power supply voltage line to the power supply voltage line and a voltage is supplied from the source device's data communication line to the data communication line, and thus bringing the switching section into an open state, whereby the voltage supplied from the source device's data communication line to the data communication line is inhibited from being supplied from the hot-plug line to the source device's hot-plug line; and detecting, when the hot-plug line is conducted to the source device's hot-plug line, the data communication line is conducted to the source device's data communication line, and the power supply voltage line is conducted to the source device's power supply voltage line, that a voltage is supplied from the source device's power supply voltage line to the power supply voltage line, and thus bringing the switching section into a conduction state, whereby the voltage supplied to the power supply voltage line is allowed to be supplied, as a hot-plug signal, from the hot-plug line to the source device's hot-plug line.

2. The hot-plug signal output apparatus according to claim 1, wherein
the power supply voltage line is connected to the data communication line through a first resistor,
the source device's hot-plug line is connected to a ground potential through a second resistor,
the switching section includes a transistor,
the output control section includes a Zener diode having a cathode connected to a control electrode of the transistor, and having an anode controlled to be connected to a ground potential,
the transistor goes into an off state by a current not flowing through the Zener diode when the hot-plug line is conducted to the source device's hot-plug line, the data communication line is conducted to the source device's data communication line, and the power supply voltage line is not conducted to the source device's power supply voltage line, and
the transistor goes into an on state by a current flowing through the Zener diode when the hot-plug line is conducted to the source device's hot-plug line, the data communication line is conducted to the source device's data communication line, and the power supply voltage line is conducted to the source device's power supply voltage line.

3. The hot-plug signal output apparatus according to claim 2, wherein a conduction start voltage of the Zener diode is determined based on resistance values of the first resistor and the second resistor, a voltage supplied to the data communication line, and a voltage supplied to the power supply voltage line.

4. A hot-plug signal input/output apparatus that accepts as input a hot-plug signal from a sink device having a sink device's hot-plug line, a sink device's data communication line, and a sink device's power supply voltage line, and outputs the hot-plug signal to a source device having a source device's hot-plug line, a source device's data communication line, and a source device's power supply voltage line, the apparatus comprising:
a hot-plug line that can be connected to the source device's hot-plug line and the sink device's hot-plug line;
a data communication line that can be connected to the source device's data communication line and the sink device's data communication line;
a power supply voltage line that is connected to the data communication line and that can be connected to the source device's power supply voltage line and the sink device's power supply voltage line;
a power supply unit that supplies a power supply voltage to the sink device's power supply voltage line through the power supply voltage line; and
output control section for detecting, when the hot-plug line is conducted to the source device's hot-plug line, the data communication line is conducted to the source device's data communication line, and the power supply voltage line is not conducted to the source device's power supply voltage line, that a voltage is not supplied from the source device's power supply voltage line to the power supply voltage line and a voltage is supplied from the source device's data communication line to the data communication line, whereby a power supply voltage is inhibited from being supplied from the power supply unit to the sink device's power supply voltage line; and detecting, when the hot-plug line is conducted to the source device's hot-plug line, the data communication line is conducted to the source device's data communication line, and the power supply voltage line is conducted to the source device's power supply voltage line, that a voltage is supplied from the source device's power supply voltage line to the power supply voltage line, whereby a power supply voltage is allowed to be supplied from the power supply unit to the sink device's power supply voltage line.

5. The hot-plug signal input/output apparatus according to claim 4, wherein
the power supply voltage line is connected to the data communication line through a first resistor,
the output control section includes a switching element that has a first electrode connected to the power supply unit and that controls the power supply unit; and a second resistor connected to a second electrode of the switching element, and
when a voltage is not supplied from the source device's power supply voltage line to the power supply voltage line and a voltage is supplied from the source device's data communication line to the data communication line, a voltage which is obtained by dividing the voltage supplied to the data communication line by the first resistor and the second resistor is supplied to the second electrode and thus the switching element goes into an off state, whereby a power supply voltage is inhibited from being supplied from the power supply unit to the sink device's power supply voltage line; and when a voltage is supplied from the source device's power supply voltage line to the power supply voltage line, the voltage supplied to the power supply voltage line is supplied to the second electrode and thus the switching element goes into an on state, whereby a power supply voltage is allowed to be supplied from the power supply unit to the sink device's power supply voltage line.

6. The hot-plug signal input/output apparatus according to claim 5, wherein
each of the hot-plug line, the data communication line, and the power supply voltage line is provided in plural number,
in the output control section, the switching element and the second resistor are provided for each of a plurality of the power supply voltage lines, and
the hot-plug signal input/output apparatus further comprises:
selection section for selecting one hot-plug line, one data communication line, and one power supply voltage line from among a plurality of the hot-plug lines, the data communication lines, and the power supply voltage lines; and
control section for supplying a control signal to a control electrode of only a switching element that is connected to the power supply voltage line selected by the selection section, the control signal being able to control the switching element to go into an on state.

7. The hot-plug signal input/output apparatus according to claim 4, wherein
the power supply voltage line is connected to the data communication line through a first resistor,
the output control section includes a switching element that has a first electrode connected to the power supply unit and that controls the power supply unit; and a second resistor connected to a control electrode of the switching element and the power supply voltage line, and
when a voltage is not supplied from the source device's power supply voltage line to the power supply voltage line and a voltage is supplied from the source device's data communication line to the data communication line, a voltage which is obtained by dividing the voltage supplied to the data communication line by the first resistor and the second resistor is supplied to the control electrode and thus the switching element goes into an off state, whereby a power supply voltage is inhibited from being supplied from the power supply unit to the sink device's power supply voltage line; and when a voltage is supplied from the source device's power supply voltage line to the power supply voltage line, the voltage supplied to the power supply voltage line is supplied to the control electrode and thus the switching element goes into an on state, whereby a power supply voltage is allowed to be supplied from the power supply unit to the sink device's power supply voltage line.
